(19) United States
(12) Patent Application Publication
(10) Pub. No.: US 2024/0068743 A1
(43) Pub. Date: Feb. 29, 2024

(54) INTEGRATED SYSTEM FOR ACCUMULATING POWER OR FOR GENERATING ELECTRIC POWER AND NATURAL GAS

(71) Applicant: SAIPEM S.P.A., Milano (IT)

(72) Inventors: Matteo BERRA, Milano (IT); Lorenzo BRUNO, Milano (IT)

(21) Appl. No.: 18/259,126

(22) PCT Filed: Dec. 22, 2021
(86) PCT No.: PCT/IB2021/062197

§ 371 Date: Jun. 23, 2023

(30) Foreign Application Priority Data
Dec. 23, 2020 (IT) 102020000032210

(51) Int. Cl. F25J 1/00; F25J 1/02; F25J 3/04

(52) U.S. Cl. CPC F25J 1/0027; F25J 1/0221; F25J 1/0242; F25J 3/04036; F25J 3/04109; F25J 3/04612; F25J 2210/50; F25J 2210/62; F25J 2210/80

(57) ABSTRACT

An integrated system for generating power and vaporizing liquefied natural gas with reduced CO₂ emissions into the atmosphere is provided.

### TECHNICAL FIELD OF THE INVENTION

The present invention finds application in the field of managing situations of excess electric power availability or excess natural gas supply.

### BACKGROUND ART

The electric power network and natural gas distribution network often need to address periods of excess intake, by producers, alternating with periods of shortage, during which the demand tends to be greater than the supply.

As for the electric power network, this crisis is aggravated by the marked increase in using renewable sources, which, because of the inherent discontinuity thereof, create a great imbalance of the network, and that is of the lack of correlation between periods of demand and periods of supply; typically, the gas network needs to address a trend of demand and supply characterized by seasonal cycles.

Attempts to find a point of equilibrium between supply and demand are based, to-date, on different strategies for the electric power network and the natural gas network.

As for the electric field, the base load is entrusted to large thermal power plants, and compensates the lack of energy, using sources of hydropower and small gas turbines; many accumulation systems have also been studied but, so far, they have proven to be costly and with limited capacity.

In contrast, the gas network is stabilized by accumulating gas in exhausted wells and importing liquefied natural gas (LNG) during periods when demand is poor, and by the release of the gas accumulated, both directly, from the wells, and for regasification of LNG.

National governments are increasingly considering gas reserves to be strategic and invest in new storages.

The main attempts at reconciliation between the production and demand of electric power comprise the use of accumulators, such as, electric batteries, CAES (Compressed Air Energy Storage) and LAES (Liquid Air Energy Storage); the latter system is the most suitable for storing large amounts of energy, although it has the disadvantage of a low efficiency due to the high energy cost of producing liquid air.

One attempt to remedy the lack of recovery of the frigories of LNG, which simultaneously increases the efficiency of LAES is described in patent documents KR 102147234B1 and CN 207420649U.

These show the use of LNG for liquefying a current of compressed air, using liquefied natural gas, which must be imported from the outside, instead of being produced from natural gas (NG); i.e., these systems consume liquefied natural gas the production of which non-renewable energy sources have contributed to.

Electric power production by means of gas turbines is no longer considered a means of producing “clean” energy, since large amounts of greenhouse gases are released into the atmosphere; furthermore, having to use a non-renewable source because it was impossible to accumulate, at least in part, the energy produced in another period from the renewable sources results in increased system costs.

As for the accumulation of gas, the storage capacity in exhausted wells is often limited, with respect to today's demands, while the regasification of LNG has the fault of not completely recovering the energy served to liquefy it.

The prior art document US 2014/245779 describes a system for the regasification of liquid natural gas, wherein the frigories of a portion of a liquefied natural gas (LNG) current are used for separating nitrogen in an Air Separation Unit (ASU), from which a flow is obtained to be send to a combustor. Downstream of the combustor, there is a step of cooling, dehydration and liquefaction of carbon dioxide by means of a second portion of the liquefied natural gas.

The prior art document JP 2001 041007 describes the combined use of liquefied natural gas (LNG) and liquefied oxygen for liquefying one same current of carbon dioxide.

### SUMMARY OF THE INVENTION

The inventors of the present patent application have developed a process, outlined in the general concepts thereof by the diagram in FIG. 1, for accumulating electric power, for example in excess with respect to the market demands, in the form of liquefied natural gas, which is then returned along with the natural gas when required.

Furthermore, the developed process allows separating carbon dioxide and liquefying it, in order to destinate it to other uses.

### OBJECT OF THE INVENTION

In a first object, the present invention describes a process for accumulating electric power, which is available, preferably in excess, in the form of production and accumulation of liquefied natural gas and liquid oxygen.

In a second object, the present invention describes a process for producing electric power, natural gas and liquid carbon dioxide.

In a third object, a method is described for stabilizing the electric power network and the natural gas network.

In a first aspect, such a method is described for accumulating electric power and for producing and accumulating liquid natural gas and liquid oxygen.

In a second aspect, such a method is described for producing electric power, natural gas and liquid carbon dioxide.

In a fourth object, the invention describes a plant for accumulating electric power in the form of production and accumulation of liquefied natural gas and liquid oxygen and/or for producing electric power, natural gas and liquid carbon dioxide.

### BRIEF DESCRIPTION OF THE DRAWINGS

FIG. 1 shows the general principle diagram of the method according to the present invention; FIG. 2A shows the diagram of a method according to a first embodiment of the present invention; FIG. 3A shows the diagram of a method according to a second embodiment of the present invention; FIG. 4A shows the diagram of a method according to a third embodiment of the present invention; FIG. 5A shows the diagram of a method according to a fourth embodiment of the present invention; FIG. 6A shows the diagram of a method according to a fifth embodiment of the present invention; FIGS. 2B, 3B, 4B, 5B and 6B show respective variants of the embodiments in FIGS. 2A, 3A, 4A, 5A and 6A where the CO₂ liquefaction unit comprises the use of a refrigerating bath and a refrigerating fluid.

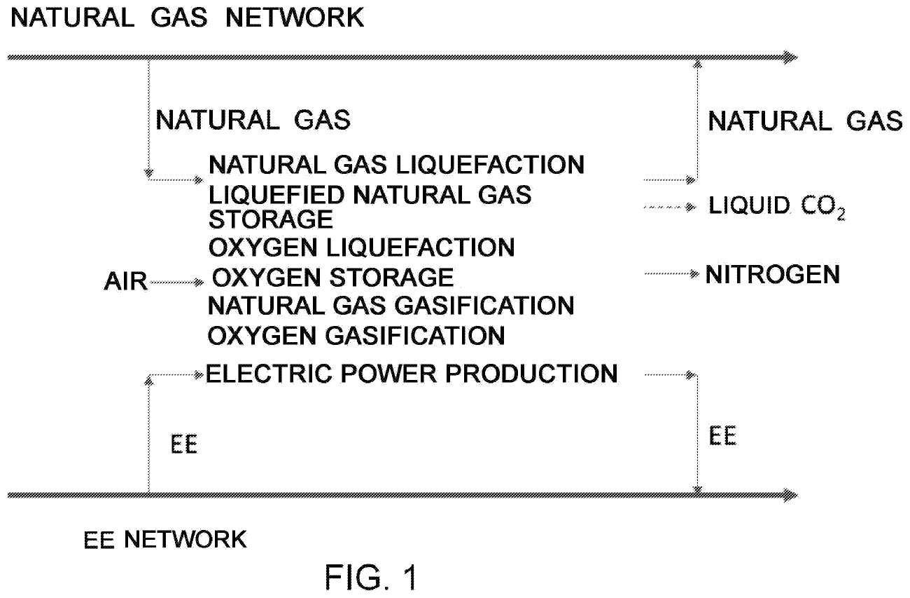

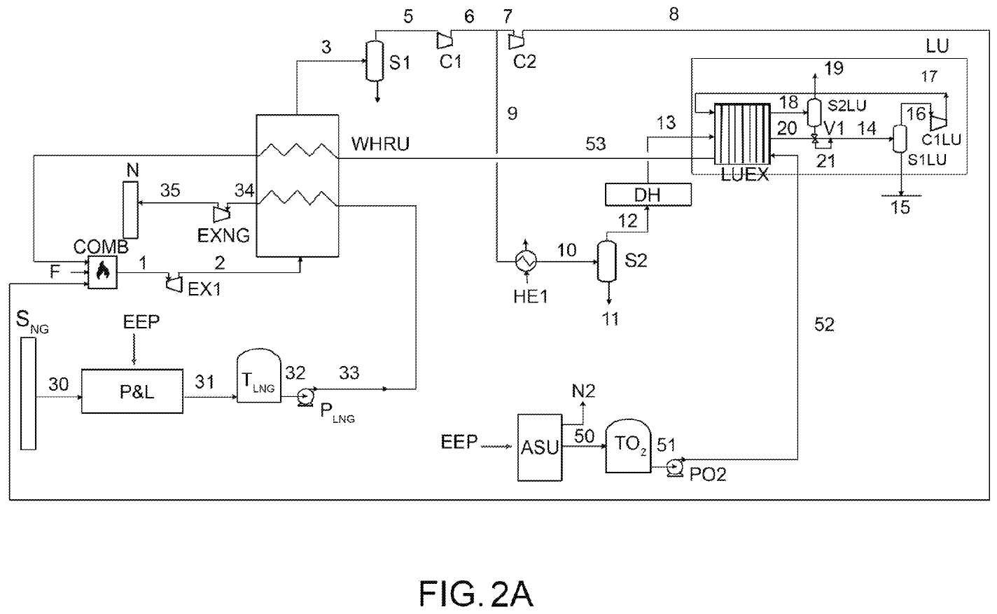

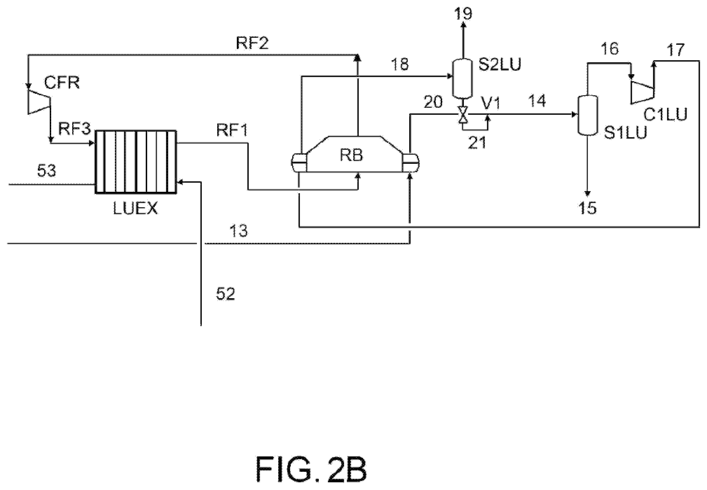

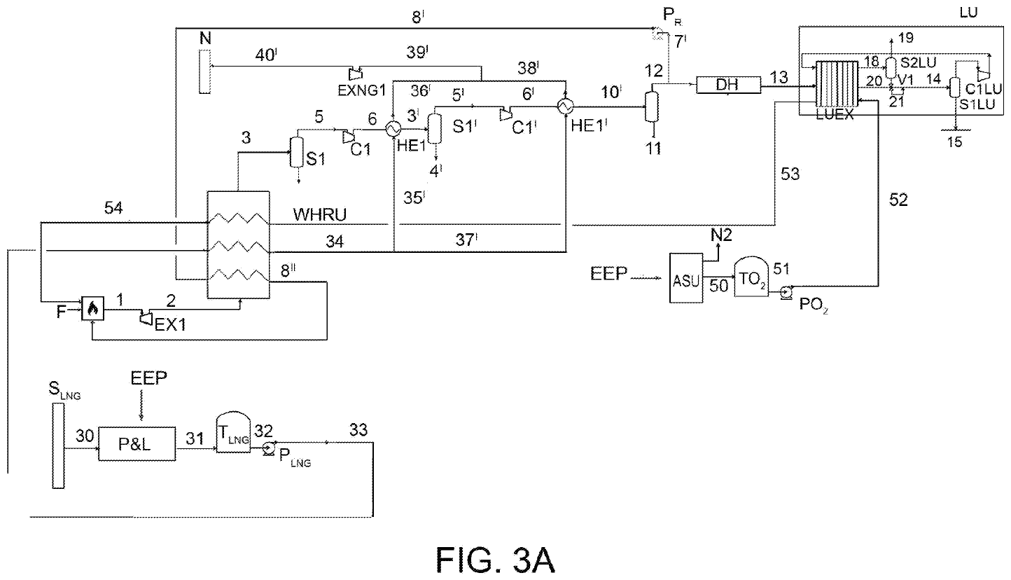

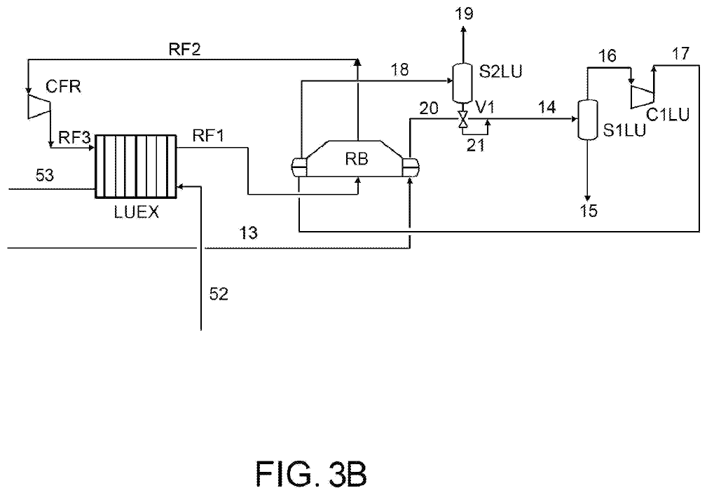

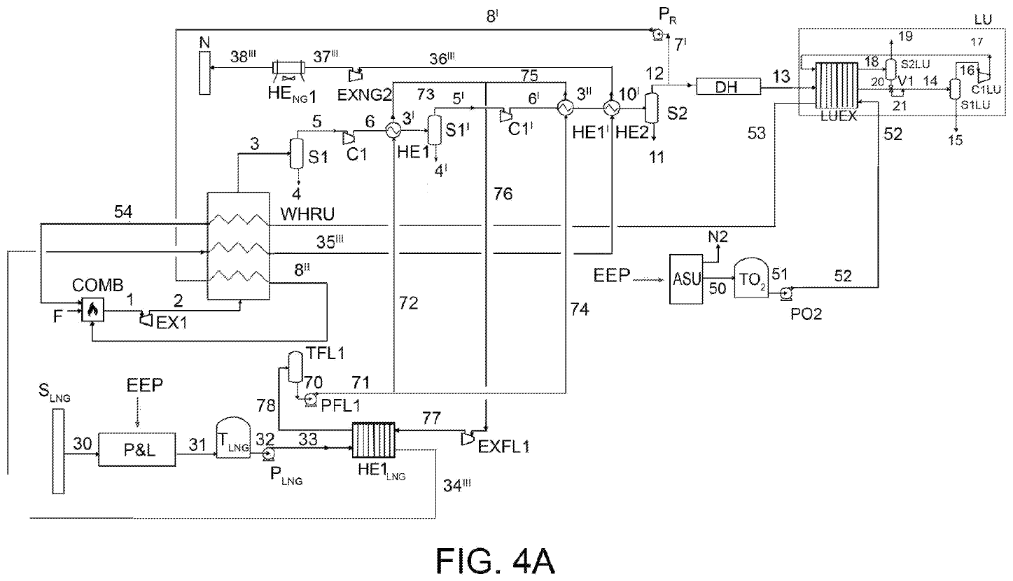

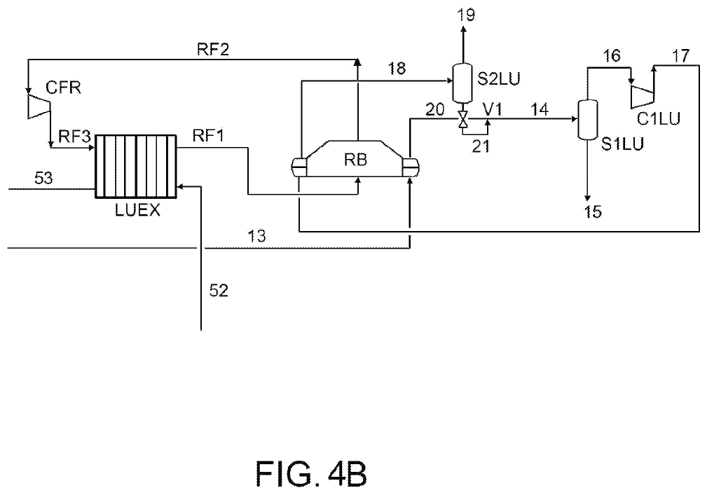

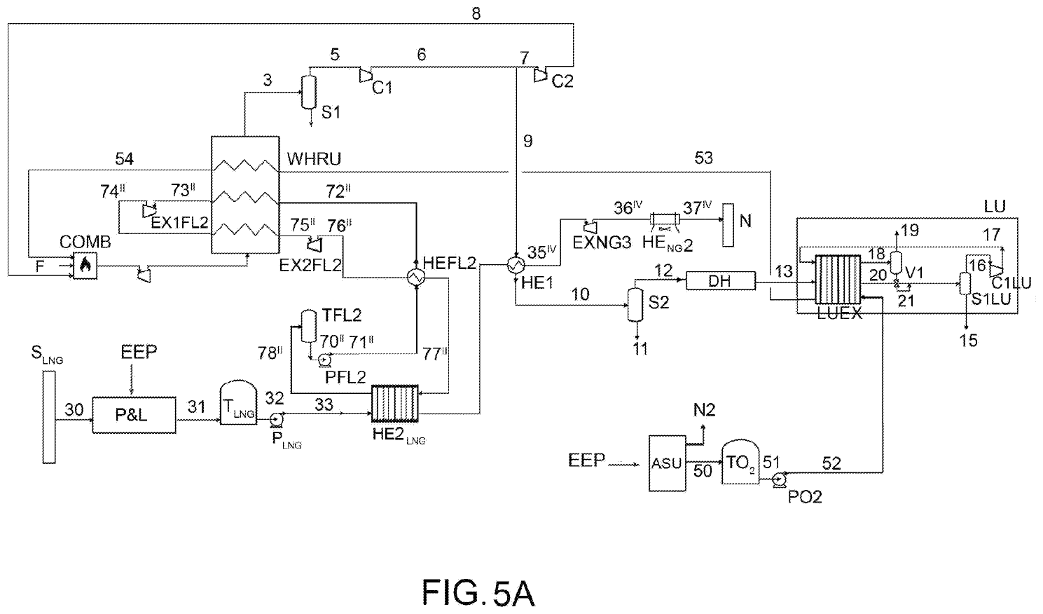

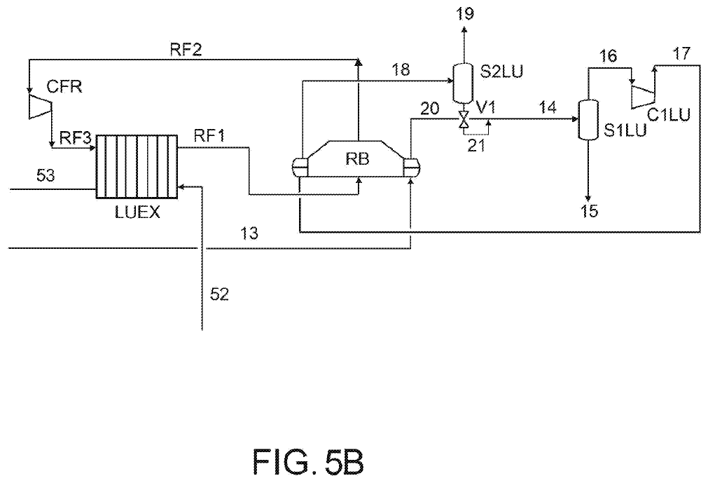

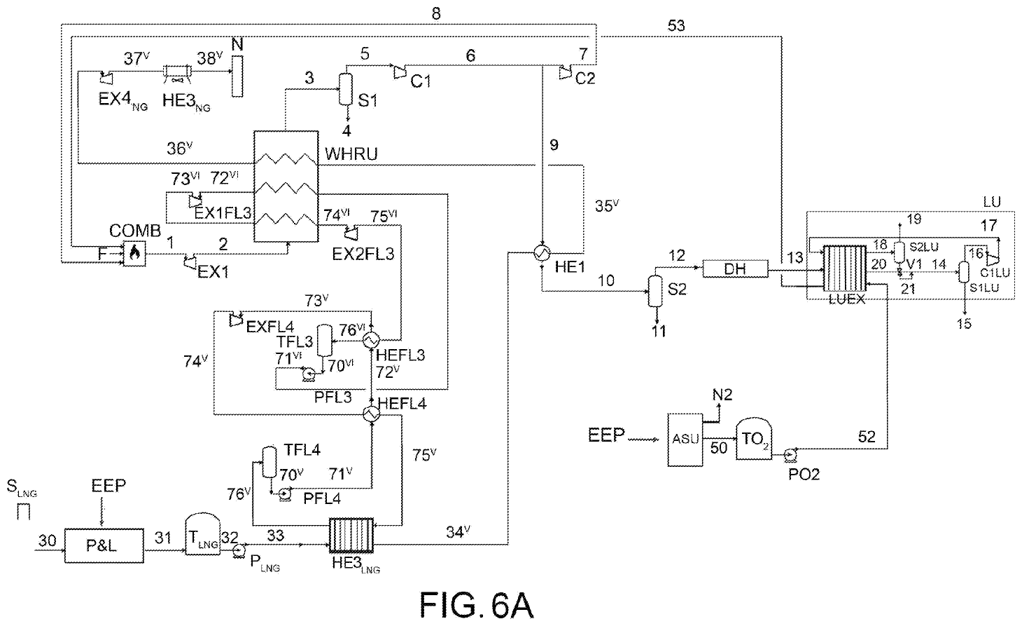

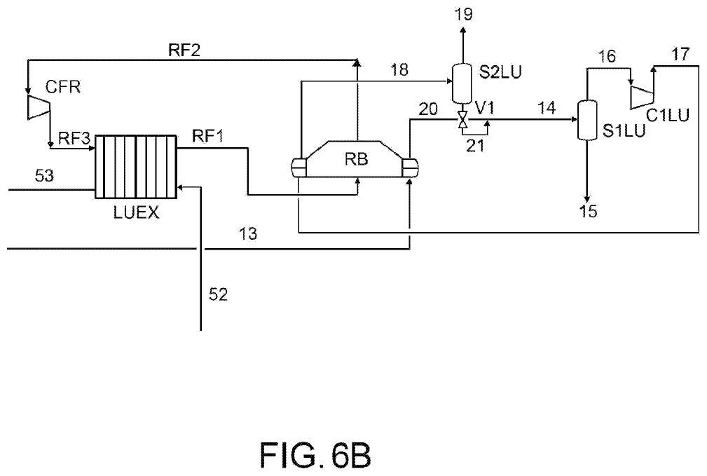

### DETAILED DESCRIPTION OF THE INVENTION

According to a first object of the invention, a process is described for accumulating electric power through the production and accumulation of liquefied natural gas and liquid oxygen.

In particular, the production and storage of liquefied natural gas starts with the liquefaction of a flow of natural gas 30 taken from a source S_{NG}, represented, for example, by the natural gas distribution network, inside a suitable purification and liquefaction unit P&L.

Advantageously, such purification and liquefaction are carried out using available electric power.

According to a preferred aspect of the present invention, such an electric power is available in excess with respect to the demand (EEP).

The flow of purified liquefied natural gas 31 thus obtained is stored in a special tank T_{LNG} at atmospheric pressure or at a higher pressure, from which an initial flow of liquefied natural gas 32 can be taken and pumped by a pump of the liquefied natural gas P_{LNG} obtaining a pumped flow of natural gas 33, which is used to implement the process according to the second object of the present invention.

In another aspect of the accumulation process, the production and storage of the liquid oxygen starts with the production of liquid oxygen from air (the input of which is not shown in the figures) in an Air Separation Unit (ASU) according to methods known in the art.

According to a particularly preferred aspect of the present invention, such a liquid oxygen production process can be carried out using the available electric power and preferably the electric power available in excess with respect to the demand (EEP).

A nitrogen flow (N₂) is also obtained from the Air Separation Unit (ASU), which can be freed into the atmosphere.

The flow of liquid oxygen 50 thus obtained is stored in a special tank at atmospheric pressure (TO₂) or at a higher pressure, from which an initial flow of oxygen 51 can be taken and pumped by means of an oxygen pump PO₂ to implement the generation process according to the second object of the present invention.

According to a second object of the invention, a process is described for producing electric power, natural gas and liquid carbon dioxide.

In particular, such a process comprises the following main steps:
step I), wherein a pumped flow of liquefied natural gas 33 is subjected to a heat exchanging step obtaining a flow of partially vaporized natural gas 34,
step II), wherein a flow of combusted gas 1 is produced from the high-pressure combustion of a fuel F, which combusted gas 1 is subjected to the sub-steps of:
   sub-step. of expansion,
   sub-step ii. of cooling,
   sub-step iii. of dehydration,
   sub-step iv. of producing a flow of liquid CO₂ 15 comprising the further cooling, purification and liquefaction, and
step III), where a flow of liquid oxygen 51 or preferably a pumped flow of liquid oxygen 52 is made available.

For the purposes of the present invention, steps I), II) and III) stated above, can be conducted at the same time, in sequence or at different times and not necessarily in the listed order.

For the purposes of the present invention, the flow of liquefied natural gas LNG in step I) is a flow at a pressure from 15-400 barg and it is obtained according to the methods of the accumulation process of the first object described above.

For the purposes of the present invention, in step II) the flow of combusted gas 1 is produced inside a combustor COMB by combustion of a fuel F in the presence of a final flow of vaporized oxygen 54.

Once produced, the flow of combusted gas 1 is subjected to a sub-step i. of expansion with power production.

In particular, such a power can be produced as electric power by using a turbine EX1.

The flow of expanded combusted gas 2 thus obtained is then subjected to the sub-step ii. of cooling, obtaining a flow of cooled expanded combusted gas 3.

For the purposes of the present invention, such a sub-step ii. of cooling comprises one or more heat exchanges inside a Heat Recovery Unit WHRU.

As described above, one of such heat exchanges of cooling is conducted according to step I) with the pumped flow of liquid natural gas 33.

For the purposes of the present invention, a further heat exchange with the flow of expanded combusted gas 2 is conducted with a flow of oxygen as described hereinafter.

In particular, a pumped flow of liquid oxygen 52 is obtained after pumping, through a liquid oxygen pump PO₂, an initial flow of liquid oxygen 51 and it is used in the heat exchange with a flow with a main composition of CO₂ 13 as described further on, obtaining a flow of partially heated oxygen 53.

Said flow of partially heated oxygen 53 performs the further heat exchange in the Heat Recovery Unit (WHRU) with the flow of expanded combusted gas 2, thus obtaining a final flow of vaporized oxygen 54.

For the purposes of the present invention, sub step iii. of dehydration comprises the steps of:
iiia) separation of the condensed water vapor,
iiib) of compression,
iiic) of cooling,
iiid) of further separation of the condensed water vapor,
iiie) of treatment in a Dehydration Unit DH.

In particular, in step iiia) the flow of cooled expanded combusted gas 3 is subjected to a separation in a first separator S1, from the bottom of which a first portion of condensed water vapor 4 is obtained and from the head of which a flow with a first level of dehydration 5 is obtained.

In step iiib), the flow with a first level of dehydration 5 is compressed in a first compressor C1 obtaining a flow with a first level of dehydration and compression 6.

For the purposes of the present invention, such a compression is implemented up to the pressure higher than the triple point of CO₂; e.g., at a pressure of less than 15 barg and preferably between 6 and 10 barg.

In step iiic), the flow with a first level of dehydration and compression 6 is subjected to a step of cooling by heat exchange in a first heat exchanger HE1 obtaining a cooled and compressed dehydrated flow 10.

According to an embodiment of the present invention, a portion 9 of said flow with a first level of compression and dehydration is subjected to step iiic), while a second portion 7 is subjected to compression in a second compressor C2 obtaining a compressed portion 8, which is sent back to the combustor COMB.

In a preferred aspect, such a compression is implemented up to the pressure of the combustion chamber or even higher.

In step iiid) the further separation of the water vapor is carried out on the cooled and compressed dehydrated flow 10 inside a second separator S2, from the bottom of which a second portion of condensed water vapor 11 is obtained and from the head of which a flow with a second level of dehydration 12 is obtained.

In step iiie) the flow with a second level of dehydration 12 is subjected to a final dehydration treatment inside a Dehydration Unit DH obtaining a flow with a main composition of CO₂ 13.

According to a preferred aspect, the treatment of the Dehydration Unit reduces the water content to a content of less than 50 ppm.

The flow with a main composition of CO₂ 13 is thus a different flow from the flow of combusted gas 1, the flow of expanded combusted gas 2 and the flow of cooled and expanded combusted gas 3, because it is enriched with CO₂.

For the purposes of the present invention, said flow with a main composition of CO₂ 13 is then subjected to a sub-step iv. of further cooling, purification and liquefaction inside a Liquefaction Unit LU thus obtaining a liquid CO₂ flow 15.

In particular, such a sub-step iv. comprises subjecting said with a main composition of CO₂ to the steps of:
iva) cooling,
ivb) separation,
ivc) compression,
ivd) further cooling,
ive) further separation.

For the purposes of the present invention, one or more of such steps from iva) to ive) can be repeated to increase the separation of CO₂; the possible repetition of such steps is carried out depending on the needs, operating conditions, complexity and consequent cost, of the plant.

More specifically, step iva) of cooling is carried out inside a heat exchanger of the liquefaction unit LUEX by heat exchange with the pumped flow of liquid oxygen 52 mentioned above.

The flow of partially heated oxygen 53 is obtained from such a heat exchange and it is sent to the heat Recovery Unit WHRU for sub-step ii.

According to a first embodiment shown, for example, in FIG. 2A, said step iva) is conducted by direct heat exchange between said pumped flow of liquid oxygen 52 and said flow with a main composition of CO₂ 13.

From step iva) a cooled flow with a main composition of CO₂ 14 is obtained, from which, in step ivb), a liquid CO₂ flow 15 is separated from the bottom of a first separator of the Liquefaction Unit S1_{LU} and a first CO₂-rich gas phase 16 from the head.

In step ivc) said first CO₂-rich gas phase 16 is compressed in a first compressor of the Liquefaction Unit C1_{LU} obtaining a first compressed gas phase 17, which is then further cooled in a step ivd) inside the exchanger LUEX obtaining a first further cooled gas phase 18.

In step ive), from said first further cooled gas phase 18, a flow of uncondensed gas 19 is further separated from the head of a second separator of the Liquefaction Unit S2_{LU} and a CO₂-rich liquid phase 20 from the bottom of said second separator S2_{LU}; such a CO₂-rich liquid phase 20 is then reunited, after lamination by means of the lamination valve V1, with the cooled flow with a main composition of CO₂ 14 to be sent to the first separator S1_{LU} for step ivb).

As for step ive), the flow of uncondensed gas 19 separated from the head of the second separator of the Liquefaction unit S2_{LU}, this is freed into the atmosphere.

Such a flow of uncondensed gas 19 mainly consists of oxygen, argon, nitrogen and traces of carbon dioxide; the latter can possibly be removed before being released into the atmosphere.

According to a second embodiment, shown, for example, in FIG. 2B, step iva) of cooling in the heat exchanger of the Liquefaction Unit LUEX is carried out by indirect heat exchange between said pumped flow of liquid oxygen 52 and said flow with a main composition of CO₂ 13.

Said exchange is obtained by means of a refrigerating fluid RF.

In particular, such a sub-step, comprises the steps of:
iv′0) obtaining by cooling in an exchanger of the Liquefaction Unit LUEX a cooled flow of a refrigerating fluid RF1,
iv′a) cooling in a refrigerating bath RB said flow with a main composition of CO₂ 13 by heat exchange with said cooled flow of the refrigerating fluid RF1 obtaining a cooled flow with a main composition of CO₂ 14 and an evaporated flow of said refrigerating fluid RF2,
iv′b) separating from said cooled flow with a main composition of CO₂ 14 a flow of liquid CO₂ 15 from the bottom of a first separator of the Liquefaction Unit S1_{LU} and a first CO₂-rich gas phase 16 from the head of said separator S1_{LU},
iv′c) compressing said first CO₂-rich gas phase 16 in a first compressor of the Liquefaction Unit C1_{LU} obtaining a first compressed gas phase 17, which is then cooled in the same refrigerating bath RB by heat exchange with the cooled flow of the refrigerating fluid RF1 obtaining an evaporated flow of the refrigerating fluid RF2 and a first further cooled gas phase 18,
iv′d) further separating, from said first further cooled gas phase 18, a flow of uncondensed gas 19 from the head of a second separator of the Liquefaction Unit S2_{LU} and a second CO₂-rich liquid phase 20 from the bottom, which is reunited, after lamination by means of the lamination valve V1, with the cooled flow with a main composition of CO₂ 14 obtained in step iv′a) and sent to the first separator S1_{LU} for step iv′b).

As for step iv′d), the flow of uncondensed gas 19 separated from the head of the second separator of the Liquefaction Unit S2_{LU}, this is freed into the atmosphere.

As described above, such a gas flow 19 mainly consists of oxygen, argon, nitrogen and traces of carbon dioxide; the latter can possibly be removed before being released into the atmosphere.

As for the evaporated flow of said refrigerating fluid RF2, this is then compressed in a compressor of the refrigerating fluid C_{FR} obtaining a compressed flow of refrigerating fluid RF3, which is cooled inside the exchanger of the Liquefaction Unit LUEX by heat exchange with the pumped flow of oxygen 52.

In a preferred aspect of the present invention, the cooling step of the flow mainly consisting of CO₂ 13 is carried out up to a temperature preferably from the triple point of CO₂ to −40° C.

As for the refrigerating fluid FR, this is represented by a suitable fluid, selected, for example, from the group comprising: CF4, Ar, etc.

In one aspect of the present invention, each of steps iiia), iiib) and iiic) can be repeated once or more times and not necessarily in sequence; for example, another step iiib) can be conducted, creating another similar flow.

According to a first embodiment, shown, for example, in FIG. 3A, by a first step iiib), a flow is obtained with a first level of dehydration and compression 6, which is cooled in a step iiic) in the heat exchanger HE1 obtaining another flow with a first level of cooled compression and dehydration 3′.

Such a flow 3′ is then subjected to another step of separation iiia′) inside another first separator S1′ from the bottom of which another first portion of condensed water vapor 4′ is obtained and from the head of which another flow with a first level of dehydration 5′ is obtained, which is subjected to another step of compression iiib′) in another first compressor C1′ obtaining another flow with a first level of compression and dehydration 6′.

Such a further flow with a first level of compression and dehydration 6′ is subjected to a subsequent heat exchange in another first heat exchanger HE1′ obtaining a cooled and compressed dehydrated flow 10, preferably at a subcritical temperature.

From such a cooled and compressed flow 10, preferably at a subcritical temperature inside a second separator S2, a second portion of condensed water vapor 11 is obtained from the bottom and a flow with a second level of dehydration 12 from the head.

Such a flow with a second level of dehydration 12 is then sent to the Dehydration Unit DH to be subjected to a dehydration treatment and obtain a flow with a main composition of CO₂ 13.

According to a preferred aspect, the treatment of the Dehydration Unit reduces the water content to a content of less than 50 ppm.

Also according to this embodiment, the flow with a main composition of CO₂ 13 is thus a different flow from the flow of combusted gas 1, the flow of expanded combusted gas 2 and the flow of cooled and expanded combusted gas 3, because it is enriched with CO₂.

Such a flow with a main composition of CO₂ 13 is then sent to the Liquefaction Unit for producing a flow of liquid carbon dioxide 15 according to the above description.

For the purposes of the present invention, the heat exchanges carried out inside the first heat exchanger HE1 and the other first heat exchanger HE1′ are carried out with the flow of partially vaporized natural gas 34 obtained after step I) or with a portion thereof.

In the present description, the flow of natural gas is subjected to successive steps of heat exchange with which it is gradually heated more and vaporized until obtaining a flow of completely vaporized natural gas to be re-introduced into the network.

As shown, for example, in FIG. 3A, a first portion of the flow of partially vaporized natural gas 35′ is separated from the flow of partially vaporized natural gas 34, and used for the direct heat exchange in the first heat exchanger HE1 with the flow of gas with a first level of dehydration and compression 6, while a second portion of the partially or totally vaporized natural gas 37′ is used for the direct heat exchange in the other first heat exchanger HE1′ with the other gas flow with a first level of dehydration and compression 6′.

The first and second portions of flow of further vaporized natural gas 36′ and 38′ thus obtained are then reunited in a single flow of further vaporized natural gas 39′, which is expanded in a first expander of the natural gas EX1_{GN} obtaining a flow of expanded natural gas 40′, which can be introduced into the network.

Power production and electric power are obtained by using a suitable expansion turbine.

According to the embodiment described above, a recycle flow 7′ is separated from the flow with a second level of dehydration 12 and pumped into a pump of the recycle flow P_{R} obtaining a pumped recycle flow 8′, which is recycled to the combustor COMB, possibly after carrying out a further cooling step of the expanded gas 2 inside the Heat Recovery Unit WHRU, obtaining a heated pumped recycle flow 8″.

According to an alternative embodiment, for example, shown in FIG. 3B, step iva) of cooling in the exchanger of the CO₂ liquefaction unit LUEX is carried out by indirect heat exchange between said flow of high-pressure liquid oxygen 52 and said flow with a main composition of CO₂ 13.

Such an indirect heat exchange is carried out according to the above description with respect to FIG. 2B.

In the embodiment shown in FIG. 4A each of steps iiia), iiib) and iiic) can be repeated.

According to a further embodiment of the invention, step iiic) of cooling is carried out by indirect heat exchange with the flow of natural gas by using a first working fluid FL1.

According to another embodiment of the invention, step iiic) of cooling can be repeated and comprise both a direct heat exchange and an indirect heat exchange with the flow of natural gas.

For the purposes of the present invention, the direct heat exchange can include a flow of natural gas:
vaporized,
partially vaporized,
   as will be described hereinafter.

In particular, the step of direct heat exchange is conducted inside a second heat exchanger HE2.

To this purpose, the pumped flow of natural gas 33 carries out a heat exchange with an exchange flow (cooled) of the first working fluid 77 inside a first heat exchanger of the liquefied natural gas HE1_{LNG} obtaining a flow of partially vaporized natural gas 34′″ and a cooled flow of the first working fluid 78, which is sent to a suitable tank T_{FL1}.

Said flow of partially vaporized natural gas 34′″ is then used and vaporized in step I) of heat exchange with the flow of expanded combusted gas 2 obtaining a flow of more vaporized natural gas 35′″, which is sent to the second heat exchanger HE2 for the direct heat exchange step.

As described above, as for the indirect heat exchange, this is obtained by using a first working fluid FL1.

In particular, a flow with a first level of dehydration and compression 6 is obtained from a first step iiib), and then cooled in a step iiic) obtaining another flow with a first level of dehydration and cooled compression 3′.

Such a further flow with a first level of cooled dehydration and compression 3′ is subjected to another step of separation inside another separator S1′ from the bottom of which another first portion of condensed water vapor 4′ is obtained and from the head of which another flow with a first level of dehydration 5′ is obtained, which is subjected to a further step of compression in another first compressor C1′ obtaining another flow with a first level of compression and dehydration 6′.

Such a further flow with a first level of compression and dehydration 6′ is subjected to a further heat exchange in another first heat exchanger HE1′ obtaining a flow with a third level of cooling 3″.

Such a flow with a third level of cooling 3″ is then subjected to a further heat exchange in the second heat exchanger HE2 obtaining another cooled and compressed dehydrated flow 10′, preferably at a subcritical temperature.

From such a further cooled and compressed dehydrated flow 10′, preferably at a subcritical temperature inside a second separator S2, a second portion of condensed water vapor 11 is obtained from the bottom and a flow with a second level of dehydration 12 is obtained from the head.

Such a flow with a second level of dehydration 12 is then sent to the Dehydration Unit DH to be subjected to a dehydration treatment and obtain the flow with a main composition of CO₂ 13.

According to a preferred aspect, the treatment of the Dehydration Unit reduces the water content to a content of less than 50 ppm.

Also according to this embodiment, the flow with a main composition of CO₂ 13 is thus a different flow from the flow of combusted gas 1, the flow of expanded combusted gas 2 and the flow of cooled and expanded combusted gas 3, being enriched with CO₂.

Such a flow with a main composition of CO₂ 13 is then sent to the Liquefaction Unit for producing a flow of liquid carbon dioxide 15 according to the above description.

For the purposes of the present invention, step iiic) comprises direct and indirect heat exchanges with the flow of natural gas.

To this end, heat exchanges are carried out in the first heat exchanger HE1 and in the other first heat exchanger HE1′ by using a working fluid.

More specifically, these are carried out with a flow of the first working fluid FL1 or with a portion thereof.

As shown for example in FIG. 4A, from a tank of the first working fluid T_{FL1}, an initial flow 70 is obtained, and pumped by a pump of the first working fluid P_{FL1} obtaining a first flow of the first working fluid 71.

A first portion 72 is separated from said first flow of the first working fluid 71 and sent to the first heat exchanger HE1 obtaining a first heated portion of said first working fluid 73, while a second portion 74 is sent to the other first heat exchanger HE1′ obtaining a second heated portion of said first working fluid 75.

The first and second heated portions of the first working fluid 73,75 are reunited, forming a single heated flow of the first working fluid 76, which is expanded in an expander of the first working fluid EX_{FL1} obtaining the exchange flow of the first expanded working fluid 77, successively cooled in the heat exchanger of the liquefied natural gas HE_{LNG} by heat exchange with the pumped flow of natural gas 33 obtaining a flow of the cooled working fluid 78, which is sent to the tank T_{FL1}, and the flow of the partially vaporized pumped natural gas 34′″.

For the purposes of the present invention, the first working fluid is represented by a fluid selected from the group comprising: water, ammonia, ethane, propane, ethylene or it can be represented by the fluid IMR, described, for example, in the international patent application WO 2020/075112 (Saipem S.p.A.).

As for the direct heat exchanges, these are conducted inside the second heat exchanger HE2.

To this end, the flow of heated partially vaporized natural gas 34′″ is subjected inside the Heat Recovery Unit WHRU to step I), obtaining a flow of more vaporized natural gas 35′″, which is thus sent to the second heat exchanger HE2.

The flow of further vaporized natural gas 36′″ thus obtained is then expanded in a second expander of the natural gas EX2_{GN} obtaining a flow of expanded natural gas 37′″, which is further heated in a first heat exchanger of the natural gas HE1_{NG} obtaining a flow of heated and expanded natural gas 38′″, which can be introduced into the network N.

In the embodiment in FIG. 4A there is comprised the separation of the recycle flow 7′, which is recycled to the combustor COMB according to the above description.

According to an alternative embodiment, for example, shown in FIG. 4B, step iva) of cooling in the exchanger of the CO₂ liquefaction unit LUEX is carried out by indirect heat exchange between said pumped flow of liquid oxygen 52 and said flow with a main composition of CO₂ 13.

Such an indirect heat exchange is conducted according to the above description with respect to FIGS. 2B and 3B.

According to an alternative embodiment, the heat exchange in step I) is an indirect heat exchange between said flow of expanded combusted gas 2 obtained in sub-step i. and the pumped flow of liquefied natural gas 33.

In particular, such an indirect heat exchange is carried out by means of a second working fluid FL2, which is cooled by heat exchange with the pumped flow of liquefied natural gas 33 inside a second heat exchanger of the liquefied natural gas EX2_{LNG}.

For the purposes of the present invention, the heat exchange step between the second working fluid FL2 and the expanded combusted gas 2 can comprise one or more sub-steps of heat exchange.

In a preferred aspect of the present invention, the present alternative embodiment is a variant of the process described above with reference to FIG. 2A.

As shown for example in FIG. 5A, from a tank of a second working fluid T_{FL2}, an initial flow of the second working fluid 70″ is obtained and pumped by a pump of the second working fluid P_{FL2} obtaining a flow with higher pressure 71″.

Such a flow with higher pressure of the second working fluid 71″ is heated in a heat exchanger of the second working fluid HE_{FL2} obtaining a heated flow 72″.

Said heated flow 72″ is then used in a cooling step of the expanded combusted gas 2 inside the Heat Recovery Unit WHRU obtaining a more heated flow of the second working fluid 73″.

Said more heated flow 73″ can be expanded in a first expander of the second working fluid EX1_{FL2} with power production and the expanded flow 74″ thus obtained is used in a further cooling step of the expanded combusted gas 2 obtaining a further heated flow of the second working fluid 75″.

Such a further heated flow 75″ can be further expanded in a second expander of the second working fluid EX2_{FL2} with power production and the further heated and further expanded flow 76″ thus obtained is employed for the heat exchange with the flow of the second high-pressure working fluid 71″ inside the exchanger of the second working fluid HE_{FL2}.

An exchange flow 77′ (cooled) is obtained, which is further cooled by heat exchange with the pumped flow of liquefied natural gas 33 inside the second heat exchanger of the liquefied natural gas HE_{LNG2} obtaining a cooled flow of the second working fluid 78″, which is stored in a dedicated tank of the second working fluid T_{FL2} at atmospheric pressure or at a higher pressure.

For the purposes of the present invention, the second working fluid is represented by a fluid selected from the group comprising: water, ammonia, ethane, propane, ethylene or it can be represented by the fluid IMR, described, for example, in the international patent application WO 2020/075112 (Saipem S.p.A.).

In the embodiment shown in FIG. 5A, after the heat exchange with the second working fluid in the second heat exchanger of the liquefied natural gas HE2_{LNG}, the flow of partially vaporized natural gas 34^{iv} thus obtained, is used in step iiic) described above, inside the first heat exchanger HE1 obtaining a flow of more vaporized natural gas 35^{iv}.

Said flow of natural gas 35^{iv} is then expanded in a second expander of the natural gas EX2_{NG} obtaining an expanded flow 36^{iv}, which is then further heated in a third heat exchanger of the natural gas HE3_{NG} obtaining a final flow of vaporized natural gas 37^{iv}, which is reintroduced into the network N.

According to an alternative embodiment, for example, shown in FIG. 5B, step iva) of cooling in the exchanger of the CO₂ liquefaction unit LUEX is carried out by indirect heat exchange between said pumped flow of liquid oxygen 52 and said flow with a main composition of CO₂ 13.

Such an indirect heat exchange is carried out according to the above description with respect to FIGS. 2B, 3B and 4B.

The embodiment described herein above is particularly suitable to the use of subcritical turbines (with respect to the condition of CO₂).

According to an alternative embodiment of the present invention shown, for example, in FIG. 6A, the heat exchange in step I) is an indirect heat exchange between said flow of expanded combusted gas 2 produced in sub-step i. and the pumped liquefied natural gas 33.

In particular, said indirect heat exchange is mediated by two working fluids.

For the purposes of the present invention, one of the two working fluids, which will be referred to as the third working fluid FL3, will carry out a heat exchange with the flow of expanded combusted gas 2 and a second heat exchange with another working fluid, which will be referred to as the fourth working fluid FL4.

For the purposes of the present invention, the step of heat exchange between said third working fluid FL3 and the expanded combusted gas 2 can comprise one or more sub-steps of heat exchange.

In turn, the fourth working fluid FL4, after carrying out the heat exchange with the third working fluid FL3, carries a second heat exchange with the pumped flow of liquefied natural gas 33.

In a preferred aspect of the present invention, such an embodiment is a variant of the processes described with reference to FIGS. 2A and 5A.

With particular reference to FIG. 6A, from a tank of a fourth cooled working fluid T_{FL4} in which it is stored at ambient pressure or at a slightly higher pressure, an initial flow 70^{v}, is obtained, which is pumped by a pump of the fourth working fluid P_{FL4} obtaining a flow of the fourth working fluid at a higher pressure 71^{v}.

Such a flow with a higher pressure of the fourth working fluid 71^{v} releases frigories in a heat exchanger of the fourth working fluid HE_{FL4} obtaining a flow of the fourth partially heated working fluid 72^{v}.

Said partially heated flow 72^{v} is then used in a heat exchange step with a flow of the third working fluid 75^{vi} in a heat exchanger of the third working fluid HE_{FL3} obtaining a further heated flow 73^{v} of the fourth working fluid FL4.

Said further heated flow 73^{v} of the fourth working fluid is then expanded in an expander of the fourth working fluid EX_{FL4} obtaining an expanded flow of the fourth working fluid 74^{v}, which, after a step of heat recovery in the exchanger of the fourth working fluid HE_{FL4} provides an exchange flow (cooled) of the fourth working fluid 75^{v}, which is sent to the exchanger of the liquefied natural gas HE_{LNG} for further cooling and condensing.

The condensed flow of the fourth working fluid 76^{v} thus obtained, is then stored in the respective tank of the fourth working fluid T_{FL4}.

As for the condensed flow of the third working fluid 76^{vi} obtained after condensation in the heat exchanger of the third working fluid HE_{FL3}, this is stored in a dedicated tank T_{FL3} at ambient pressure or at a slightly higher pressure.

From said tank T_{FL3}, an initial flow of the third working fluid FL3 70^{vi} is obtained, which is pumped by a pump of the third working fluid P_{FL3} obtaining a flow with a higher pressure 71^{vi}.

Such a flow with a higher pressure of the third working fluid 71^{vi} is used in step I) of heat exchange with the flow of expanded combusted gas 2 inside the Heat Recovery Unit WHRU obtaining a partially heated flow of said third working fluid 72^{vi}.

Said partially heated flow of the third working fluid 72^{vi} can then be expanded in a first expander of the third working fluid EX1_{FL3} obtaining an expanded flow 73^{vi}.

Said expanded flow 73^{vi} is then used in a second heat exchange step with the flow of expanded combusted gas 2 inside the Heat Recovery Unit WHRU obtaining a further heated flow of the third working fluid 74^{vi}.

Said further heated flow of the third working fluid 74^{vi} can be then expanded in a second expander of the third working fluid EX2_{FL3} obtaining a further expanded flow 75^{vi}, which is used in the heat exchange step with the flow 72^{v} in the heat exchanger of the third working fluid HE_{FL3}.

In the embodiment shown in FIG. 6A, besides the indirect exchange, a direct heat exchange is also carried out between the liquefied natural gas and the expanded combusted gas 2.

In fact, after the heat exchange with the fourth working fluid FL4 inside the third heat exchanger of the liquefied natural gas HE3_{LNG}, the flow of partially or completely vaporized natural gas 34^{v} obtained is used in step iiic) inside the first heat exchanger HE1 obtaining a flow of more vaporized natural gas 35^{v}.

Said flow of natural gas 35^{v} is then used in a direct heat exchange step with the expanded combusted gas 2 inside the Heat Recovery Unit WHRU obtaining a flow of heated natural gas 36^{v}.

Said heated flow 36^{v} is then expanded in a fourth expander of the natural gas EX4_{NG} obtaining an expanded heated flow 37^{v}, which is then further heated in a third heat exchanger of the natural gas HE337v_{NG} obtaining a final flow of vaporized natural gas 38^{v}, which is reintroduced into the network N.

According to an alternative embodiment, for example, shown in FIG. 6B, step iva) of cooling in the exchanger of the CO₂ Liquefaction Unit LUEX is carried out by indirect heat exchange between said pumped flow of liquid oxygen 52 and said flow with a main composition of CO₂ 13.

Such an indirect heat exchange is carried out according to the above description with respect to FIGS. 2B, 3B, 4B and 5B.

Also according to this embodiment, the flow with a main composition of CO₂ 13 is thus a different flow from the flow of combusted gas 1, the flow of expanded combusted gas 2 and the flow of cooled and expanded combusted gas 3, because it is enriched with CO₂.

For the purposes of the present invention, the third working fluid can be represented by a fluid selected from the group comprising: water, ammonia, propane, etc.

For the purposes of the present invention, the fourth working fluid can be represented by a fluid selected from the group comprising: ethane, ethylene, propane, etc. and which, in a preferred aspect, is represented by the fluid IMR, described, for example, in the international patent application WO 2020/075112 (Saipem S.p.A.).

According to a third object, the present invention describes a method for stabilizing the electric power network and the natural gas network.

In particular, in a first aspect, such a method is described for accumulating electric power through the production and accumulation of liquefied natural gas and liquid oxygen.

In a second aspect, the method of the invention is described for generating electric power, natural gas and liquid carbon dioxide.

In particular, such a method comprises carrying out the process according to a first object and the process of the second object according to one of the embodiments of the present invention described above.

For the purposes of the present invention, the production of liquefied natural gas and liquid oxygen is obtained with an amount of electric power, available, preferably in excess, with respect to the demand (EEP).

According to a fourth object of the invention, a plant is described for producing electric power, natural gas and liquid carbon dioxide.

In particular, such a plant comprises:
I) a liquefied natural gas regasification line comprising one heat exchanger,
II) an energy production unit comprising a combustor (for example, for oxy-combustion, an expander, and a Heat Recovery Unit WHRU,
III) a gaseous oxygen production unit comprising one heat exchanger,
IV) a CO₂ cooling, purifying, and liquefying line, comprising one heat exchanger,
V) a liquid oxygen preparation unit comprising an air separation unit (ASU),
VI) a liquefied natural gas preparation unit, comprising a Purification and Liquefaction Unit (P&L).

For the purposes of the present invention, the heat exchanger of the liquefied natural gas regasification line is represented by the Heat Recovery Unit WHRU.

For the purposes of the present invention, the heat exchanger of the gaseous oxygen production line is represented by the heat exchanger of the CO₂ liquefaction unit LUEX.

From the above description of the present invention, the advantages offered by the present invention will be immediately apparent to those skilled in the art.

By virtue of the process and the method of the present invention, a storage of gas and the stabilization of both the gas and electric distribution networks can be obtained at the same time, also obtaining the sequestration of CO₂ which would otherwise be introduced into the atmosphere if the electric power were produced using traditional systems.

Various technologies exist for liquefying the natural gas, each characterized by a different system complexity and energy expenditure for condensing LNG, just as different types of machines can be applied to the operations of recovering energy from the fumes produced in the Oxyfuel Combustion.

Considering the fact that LNG is produced from gas taken at the network pressure, and that only limited operations of upgrading are required, an energy expenditure at 0.2 kWh/kg is estimated for the production thereof.

Based on these figures, the embodiments of the process of the present invention offer an efficiency as compared to the thermal power introduced (obtained only from the combustion) varying between 80% and 55%, and a global efficiency, i.e., also considering the electric power needed for the production of LNG, varying between 50% and 35%.

The suggested systems interface with both gas and electric power networks and are configured as damping/stabilization systems by means of energy accumulation.

1-18. (canceled)

19. A process for producing electric power, for producing natural gas and liquid carbon dioxide, comprising the steps:
I) subjecting a pumped flow of liquefied natural gas to heat exchange, obtaining a flow of partially vaporized natural gas,
II) producing a flow of combusted gas from high-pressure combustion of a fuel and subjecting the flow of combusted gas to the sub-steps of:
i. expansion, obtaining a flow of expanded combusted gas with power production,
ii. cooling,
iii. dehydration,
iv. further cooling, purifying, and liquefying, obtaining a flow of liquid CO₂ and a flow of partially heated oxygen, and
III) making available a pumped flow of liquid oxygen,
wherein in step I) the heat exchange is carried out with the flow of expanded combusted gas obtained in step i., and in sub-step iv. the pumped flow of liquid oxygen of step III) is used to obtain said flow of partially heated oxygen.

20. The process of claim 19, wherein sub-step ii. further comprises a step of heat exchange with the flow of partially heated oxygen obtained in sub-step iv.

21. The process of claim 19, wherein after step I), the flow of partially vaporized natural gas is subjected to expansion with power production.

22. The process of claim 19, wherein sub-step iii. comprises the steps of:
iiia) separating a first portion of condensed water vapor and a flow with a first level of dehydration in a first separator,
iiib) compressing the flow the first level of dehydration in a first compressor obtaining a flow with a first level of compression and dehydration,
iiic) cooling the flow with the first level of compression and dehydration in a first heat exchanger obtaining a compressed, cooled, and dehydrated flow, and
iiid) further separating a second portion of condensed water vapor and a flow with a second level of dehydration in a second separator, and
iiie) treatment the flow with the second level of dehydration in a dehydration unit obtaining a flow with a main composition of CO₂,
wherein each of steps iiib), iiic) and iiid) may be repeated several times.

23. The process of claim 22, wherein a second portion of the flow with the first level of compression and dehydration obtained in step iiib) is separated and recycled to a combustor after a compression step in a second compressor obtaining a compressed recycle portion.

24. The process of claim 19, wherein sub-step iv. comprises the steps of:
iva) cooling said flow with a main composition of CO₂ in a heat exchanger of a CO₂ liquefaction unit obtaining a cooled flow with a main composition of CO₂,
ivb) separating, from said cooled flow with a main composition of CO₂, a flow of liquid CO₂ from the bottom of a first separator of the liquefaction unit and a first CO₂-rich gas phase from a head of said first separator of the liquefaction unit,
ivc) compressing said first CO₂-rich gas phase in a first compressor of the liquefaction unit obtaining a first compressed gas phase,
ivd) further cooling said first compressed gas phase in said CO₂ liquefaction unit by heat exchange with the pumped flow of liquid oxygen obtaining a first further cooled gas phase and said flow of partially heated oxygen, and
ive) further separating, from said first further cooled gas phase, a flow of uncondensed gas from a head of a second separator of the liquefaction unit and a CO₂-rich liquid phase from the bottom, reunited, after lamination by a lamination valve, with the cooled flow with a main composition of CO₂ obtained in step iva).

25. The process of claim 24, wherein said step ivd) of further cooling is a step iv′d) carried out by indirect heat exchange with said pumped flow of liquid oxygen.

26. The process of claim 25, wherein step iv′d) comprises the sub-steps of:
iv′0) obtaining by cooling in the heat exchanger of the CO₂ liquefaction unit a cooled flow of a refrigerating fluid by heat exchange with said pumped flow of liquid oxygen,
iv′a) cooling in a refrigerating bath said flow with a main composition of CO₂ by heat exchange with said cooled flow of the refrigerating fluid obtaining the cooled flow with a main composition of CO₂ and an evaporated flow of said refrigerating fluid,
iv′b) separating, from said cooled flow with a main composition of CO₂, a flow of liquid CO₂ from the bottom of the first separator of the liquefaction unit and a first CO₂-rich gas phase from the head of said first separator of the liquefaction unit,
iv′c) compressing said first CO₂-rich gas phase in the first compressor of the liquefaction unit obtaining a first compressed gas phase,
iv′d) further cooling said first compressed gas phase in the refrigerating bath by heat exchange with the cooled flow of the refrigerating fluid obtaining an evaporated flow of the refrigerating fluid and the first further cooled gas phase,
iv′e) further separating, from said first further cooled gas phase, a flow of uncondensed gas from the head of the second separator of the liquefaction unit and the second CO₂-rich liquid phase from the bottom, which is reunited, after lamination by the lamination valve, with the cooled flow with a main composition of CO₂ obtained in step iv′a).

27. The process of claim 22, wherein in step iiic) said cooling is obtained by heat exchange with the flow of partially vaporized natural gas obtained in step I) or with a portion of a flow of more vaporized natural gas.

28. The process of claim 22, wherein a plurality of steps iiib), iiic) and iiid) is carried out and before step iiie), a recycle portion is separated and pumped by a pump obtaining a high-pressure recycle portion, which is used in a step of heat exchange with said flow of expanded combusted gas obtaining a heated recycle flow recycled to combustor.

29. The process of claim 22, wherein in step iiic) said cooling is obtained by heat exchange with one or more portions of a first working fluid, which is cooled by heat exchange with the pumped flow of liquefied natural gas.

30. The process of claim 19, wherein said heat exchange of step I) is an indirect heat exchange between said flow of expanded combusted gas obtained in sub-step i. and said pumped flow of liquefied natural gas.

31. The process of claim 20, wherein said indirect heat exchange comprises a step of heat exchange between said pumped flow of liquefied natural gas and a flow of a second working fluid obtaining a cooled flow of said second working fluid.

32. The process of claim 31, wherein one or more steps of heat exchange are carried out with the flow of expanded combusted gas obtaining respective heated flows of said second working fluid, wherein each of said heated flows of said second working fluid is subjected to a step of expansion in a respective first and/or possibly second expander of the second working fluid with power production.

33. The process of claim 22, wherein in step iiic) said cooling is obtained by heat exchange with a flow of natural gas obtained after heat exchange with a flow of said second working fluid obtaining a flow of partially heated natural gas which is used in step I).

34. The process of claim 19, wherein said pumped flow of liquid oxygen and said pumped flow of liquefied natural gas are obtained from respective amounts of liquid oxygen and liquefied natural gas produced by using electric power available in excess.

35. A method for stabilizing an electric power network and a natural gas network, the method comprising carrying out a process according to claim 19, wherein flows of natural gas and oxygen are obtained from an amount of liquefied natural gas and liquid oxygen produced by using an amount of electric power available in excess.

36. A plant for producing electric power, natural gas, and liquid carbon dioxide, comprising:
I) a liquefied natural gas regasification line comprising a heat exchanger,
II) an energy production unit comprising a combustor, an expander, and a waste heat recovery unit (WHRU),
III) a vaporized oxygen production unit comprising a heat exchanger,
IV) a CO₂ liquefaction unit, comprising a heat exchanger,
V) a liquid oxygen preparation unit comprising an air separation unit (ASU),
VI) a liquefied natural gas preparation unit, comprising a purification and liquefaction unit, wherein
the heat exchanger of the liquefied natural gas regasification line is represented by said WHRU and
the heat exchanger of the vaporized oxygen production unit is represented by the heat exchanger of the CO₂ liquefaction unit.

37. The plant of claim 36, wherein the combustor of the energy production unit is an oxy-combustor.
